(19) United States
(12) Patent Application Publication
(10) Pub. No.: US 2018/0012133 A1
(43) Pub. Date: Jan. 11, 2018

(54) Method and system for behavior control of AI-based systems.

(71) Applicants: Ralf Steiner, Zeitz (DE); Elke Unbehaun, Frankleben (DE)

(72) Inventors: Ralf Steiner, Zeitz (DE); Elke Unbehaun, Frankleben (DE)

(21) Appl. No.: 15/628,662

(22) Filed: Jun. 21, 2017

Related U.S. Application Data
(60) Provisional application No. 62/360,440, filed on Jul. 10, 2016.

(51) Int. Cl. G06N 5/04; G06N 99/00

(52) U.S. Cl. CPC G06N 5/047; G06N 99/005

(57) ABSTRACT

Method and system for behavior control of AI-based systems comprising at least one processor connected to a clock to measure time and to a memory, wherein said AI-based system is independently operable.

### BACKGROUND OF THE INVENTION

### 1. Field of the Invention

The principles of the present disclosure describe a method, computer program, device and system for behavior control of AI-based systems, in particularly to protect these against internal caused changes as well as against external caused bugs when updating or upgrading or changing the AI-system.

For a human-being with the ability of self-consciousness it is usual that he/she is responsible for his/her actions. For all these natural persons a causally sequence is assumed: ‘thinking—(speaking)—acting’ by the philosophically concept of the free will.

Based on this the law created institutions like liability. Similar for units of natural persons acting on market and represented by natural persons like corporations a so-called ‘legal person’ was created. Driven by the developments of electronic systems in last years the AI based computer-systems have broken in special fields like games such as Chess and Go the winning-dominance of the human-brain. Thus it is consequently that in many countries the politics think about a further similar institution of an ‘electronic person’ such as known from futuristic novels. This will be followed by a so called ‘robotic ethics’.

Beside above developments in law and moral philosophy a practicable technically method and a system for a behavior control of AI-based systems such as independently working robots, service robots, as well as independently mobile devices on land or water, in water, air or space and also independently decision taking systems in economics, banking, trading and so on is herewith described.

### Definitions:

Artificial intelligence (AI) is the intelligence exhibited by machines. Such an ideal ‘intelligent’ machine is a flexible rational agent that perceives its environment and takes actions that maximize its chance of success at an arbitrary goal. Such AI systems can also take into account in their decision random elements. Modern examples of AI-based systems include computers that can beat professional players at Chess and Go, and independently driving cars that navigate crowded city streets. The term “AI-system” also covers a cooperative set of independent AI-agents working together to reach a common goal like team-players.

For the definitions of other used specialized terminology like ‘phase space’, ‘observable’ and ‘quasi-particle’ and so one their definition from the English wikipedia project on the filing date is used in this specification.

### 2. Description of the Related Art

The European patent application EP1857982 discloses a device comprises a sensor for recording the condition of a component of an auxiliary vehicle. A diagnostic system receives the output signal of sensors, where the output signal is stored in the data transmission system. The stored data is conveyed to a stationary data base.

A senior editor for AI: (Will Knight; Apr. 11, 2017; https://www.technologyreview.com/s/604087/the-dark-secret-at-the-heart-of-ai/) recently reports that intelligence analysts from the Defense Advanced Research Projects Agency (DARPA) were testing machine learning in recent decades as a way of identifying patterns in vast amounts of surveillance data. Instead of a programmer writing the commands to solve a problem, the program generates its own algorithm based on example data and a desired output. The machine-learning techniques that would later evolve into today's most powerful AI systems followed the latter path: the machine essentially programs itself. Deep learning is responsible for today's explosion of AI. It has given computers extraordinary powers, like the ability to recognize spoken words almost as well as a person could, a skill too complex to code into the machine by hand. Deep learning has transformed computer vision and dramatically improved machine translation.

The many layers in a deep network enable it to recognize things at different levels of abstraction. Thus the German Patent application DE19923622 describes a system in the form of a neural network that is formed with weighted elements that are based upon the special characteristics of an Hilbert space. The elements are functionally connected by a coordinate vector. The same approach can be applied, roughly speaking, to other inputs that lead a machine to teach itself: the sounds that make up words in speech, the letters and words that create sentences in text, or the steering-wheel movements required for driving. Also the car's underlying AI technology, known as deep learning, has proved very powerful at solving problems in recent years, and it has been widely deployed for tasks like image captioning, voice recognition, and language translation. Google researchers noted that when its algorithm generated images of a dumbbell, it also generated a human arm holding it. The machine had concluded that an arm was part of the thing.

If you could get access to the used mathematical models, it would be possible to understand their reasoning. But banks, the military, employers, and others are now turning their attention to more complex machine-learning approaches that could make automated decision-making altogether inscrutable. Deep learning, the most common of these approaches, represents a fundamentally different way to program computers. The computers that run those services have programmed themselves, and they have done it in ways a human-being cannot understand. Even the engineers who build these apps cannot fully explain their behavior. Thus using AI requires a leap of faith. Sure, we humans can't always truly explain our thought processes either—but we find ways to intuitively trust and gauge people. If that's so, then at some stage we may have to simply trust AI's judgment or do without using it. Likewise, that judgment will have to incorporate social intelligence.

The US patent application US20120302824 discloses a self-moving hand- and voice controlled human-like partner-robot comprising a processor, a memory and sensors for immediately interactions with human-beings of booth gender.

Based on a principle of the German philosopher Nietzsche the will of each subject is to broader itself only limited by the will of another subject. With the assumption that also the effect of this will is generally describable also with physically models thus the birth of the will as such and also significant changes of its characteristic will be measurable with physically means. Thus the physicist Wissner-Gross shows that an intelligent system is to be characterized by an entropy force acting in a direction to broader his general freedom of action describable by the statistical number of possible abstract states in the field of statistical physics.

Accordingly, it is an object of the present invention to provide a behavior control of AI-based systems based on statistical physics.

### SUMMARY OF THE INVENTION

The present invention overcomes the deficiencies and limitations discussed in the Background section at least in part by providing innovative systems, devices, programs and methods for behavior control of AI-based systems.

Method for behavior control of an AI-based system, comprising at least one processor connected to a clock to measure time and to a memory, wherein said AI-based system is independently operable and is executing over the time at least the sequence of steps:
a) sample at least one physically observable of said AI-based system;
b) creation of at least one pair of variables dependent from said observables and/or from derivatives of said observables;
c) transformation of said at least one pair of variables into a multidimensional phase space;
d) creation of exactly one (unidimensional oriented) path within said phase space based on the sequence in time of said pairs of variables;
e) detect deviations of said path (which is related to the behavior of said AI-based system);
f) in the case of a deviation of the behavior of said AI-based system generate an information about the deviating behavior.

By this innovative solution the real measured behavior of any AI-based system is mathematically modeled by means of statistical physics which allow a classification of the development over time of said AI-based system. Thus each deviation of the usual behavior of said AI-based system is detectable, particularly unexpected or unwanted behavior, by an independent supervising authority. These may caused by changes driven by bugs in updates of the AI-based system, or other deviations of the AI-based system over time. Particularly a behavioral authentication of an AI-based system, which might consist of an AI controlling an object with at least one mechanical actor, which might be a robotic arm or a motor to move a movable object, or any other possibility to interact with the mechanical world or more generally with the physically describable world is realizable.

In some embodiments, in step a) ‘sample’ at least one physically observable of the AI-based system and at least one physically observable of the environment of said AI-based system is used. Thus any interaction of the environment with the AI-based system are controlled.

In some embodiments, said step e) ‘detect deviations’ comprises the sub-steps:
detection of at least one periodic pattern of said path within said phase space;
only if at least one pattern was recognized than:
only if said path leaves a given bandwidth of said pattern(s) than:
a derivation is detected.
   Thus well known mathematically methods for pattern recognition are usable for the detection based on the fact that a usually behavior of a physical system and also an AI-based system will not change a given pattern of its path in phase space.

In some embodiments at least parts of said path are analyzed towards virtual displacements between two fixed ends to detect extremal values of terms from said pairs of variables, whereby the curvature on said extremal value is used to detect derivations. Thus the fact, based on D'Alembert's principle that the total virtual work vanishes for reversible displacements, is used to distinguish the behavior of the AI-based system between expected and not expected in thus a sense that an acceptable AI behavior shows a positive curvature related to a minimum principle of the nature and non acceptable AI behavior shows a negative curvature related to a maximum principle.

In some alternative embodiments, the process of distinguishing acceptable from non acceptable AI behavior is consisting of the following steps:
a) creating an empty behavioral profile of AI behavior;
b) in a learning phase gathering of external accessible data of the AI behavior of a AI-based system, these might include mechanical accessible data like position, direction, speed, velocity and the like;
c) training the AI behavioral profile using said gathered external accessible data of the AI-based system;
d) if no significant (explicit defined or above a threshold of 20%) new AI behavior captured the AI behavioral profile is deemed to be fully trained;
e) in an authentication phase, comparing newly captured AI behavior to already captured/trained AI behavior;
f) if newly captured AI behavior is substantial (explicit defined or more than 20% relative) different to already captured AI behavior than:
g) inform a supervising authority, these supervising authority may be a third party related to said AI-based system by a contract.

Thus it is possible to define specific “boundaries” for acceptable behavior like “drive not faster than x miles” or “don't pass a double line” and supervise this by the behavior control system of the supervising authority.

In some embodiments, in said step b) ‘learning phase’ further is checking, if all “boundaries” of acceptable AI behavior are met. Thus the whole multidimensional acceptance profile is covered by this check.

In some embodiments, said step b) ‘learning phase’ is comprising the sub-steps:

If newly gathered AI behavior is matching (fuzzy, AI, deep learning) AI behavior captured in the training period, than accept this AI behavior as newly captured AI behavior and further train said AI-based system;
Else don't accept this AI behavior and inform said supervising authority.
   Thus the acceptable AI behavior will developed itself over time.

In some embodiments said patterns are recognized by methods of Symbolic Model Verification (SMV) whereby large numbers of states of the phase space were considered at a single step using Kernel-based Virtual Machines (KVM) for hardware virtualization or ‘deep learning’ as a branch of machine learning based on a set of algorithms that attempt to model high-level abstractions in data by using a deep graph with multiple processing layers, composed of multiple linear and non-linear transformations. Thus reliable methods for ‘Big Data Analysis’ and ‘Data Mining’ are useable.

In some embodiments disjoint areas of said patterns itself were used to detect derivations. Thus the fact, based on the ergodic hypothesis that all accessible states of the phase-space are equiprobable over a long period of time, is used that disjoint areas in phase space sign a ‘spontaneous symmetry breaking’ and thus a new physical entity.

In some embodiments said recognized patterns were compared to stored patterns of similar AI-based systems to detect derivations, optionally dependent from the local density of the paths of the phase space. Thus the fact, based on Liouville's Theorem that the local density of states following a path of one system through the phase space is constant as viewed by an observer moving with an ensemble of similar systems, is used that derivations of the local density sign a change of the observed system relating to the mean field of all other systems.

In some embodiments said stored patterns are older ones from said AI-based system itself, optionally from times before an update of at least a part of said AI-based system was downloaded. Thus the behavior of one and the same AI-based system is comparable before and after an update was performed and by this way possible bugs or malware are detectable.

In some embodiments the following information of a “mechanically operating” mechanical AI-based systems can be gathered: mechanical actions for a mechanical actor or extremity, which might be a robotic arm, robotic hand or finger speed, velocity, direction and so on. Furthermore certain circumstances of the surrounding of the mechanical AI-based systems can be gathered, like external objects as well as speed, directional velocity and so on of these external objects. Using this gathered information about external objects, further AI behavior of the AI-based system, as a reaction on those external objects can be gathered and trained into the AI behavioral profile of said AI-based system. Thus any mechanical dangerous actions of thus AI-based systems are limited.

In some embodiments the information about the deviating behavior can be sent to an (independent) supervising authority or be used to stop the AI controlled object. Thus a third party will be able to protect any dangerous actions of thus AI-based systems for the future by reasonable actions.

In some embodiments the AI-based system has to be checked itself, optionally using a data connection to an (independent) supervising authority, at each start time before it is able to command the AI controlled object. Thus a third party will be able to protect any dangerous actions of thus AI-based systems in advanced and in a periodic and practicable way, such as for AI controlled cars.

In some embodiments by effectively running the algorithm of the AI-based system in reverse, the supervising authority could discover the features the AI-based system uses to recognize different objects and to choice different decisions. Thus a kind of rational understanding is realized.

In some embodiments said robotic actor might be a car or another mechanical moved object like a walking robot with additional “extremities”. Thus any mechanical dangerous actions in traffic of thus AI-based systems are limited.

A remote computer software system might be a computer system connecter to said AI-base system by network means, where said remote computer software system might be a traditional software computer system with or without mechanical actors or another AI-based software or a software system with mechanical actors, which might be AI operated or by a traditional software on a computer system.

In another embodiment, the inventive method respectively the inventive system can be used to supervise AI-based systems with are only acting in an informational space with no direct mechanical actors like mechanical extremities, such like trading platforms or computers in economic areas or other informational entities, like chat-bot or other AI driven software based decision engines. Thus also the interaction of said AI-based systems with entities without any mass but physically describable (as quasi-particle) are controllable.

In some embodiments the following behavior of such an AI-based system can be captured: storing information in a non transient or transient memory connected or part of said AI-based system, opening, maintaining or closing a connection to a remote computer system, delivering or receiving data from said remote system, the content of the delivered or received data from said external system. Using this gathered information about external objects and the AI behavior of said AI-based systems, as a reaction on those external objects can be gathered and trained into the AI behavioral profile of said AI-based system.

In some embodiments the capturing of these information might be realized by supervising the information flow between the AI-based system and other remote systems, by intercepting the possible information flows between those systems by enclosing the AI-based system into a “shell” where the AI-based system is only capable to communicate with other remote systems through this shell, so that all information flows can be intercepted. Thus any informational dangerous actions of thus AI-based systems are limited.

In some embodiments the capturing of these information realized by supervising the information flow is based on detecting of biased decision-making in relation to a larger set of similar supervised AI-based system, such as racism, gender and belief depending behavior. Thus by this kind of behavior analysis an ethic AI watchdog with social intelligence is established.

There is further provided, in accordance with an embodiment of the present invention, a method of gathering of external accessible data of the state of an only informational object such as a software system operated by an AI. These might include informational accessible data, like connections, informational transmissions, amount of data transferred, type of data transmitted and so on.

There is further provided, in accordance with an embodiment of the present invention, an algorithm of above described method executable on a processor. Thus the method is executable by any systems comprising a processor, particularly by said AI-based system itself but also by centralized instances to simulate such a AI-based system.

There is further provided, in accordance with an embodiment of the present invention, an information carrier of said algorithm of above described method. Thus the information carrier such as a CD or memory-stick containing the algorithm is classically distributable. Advantageous the information carrier may be an electrical or electromagnetical signal modulated with said algorithm. Thus the algorithm is wired or wireless distributable too.

There is further provided, in accordance with an embodiment of the present invention, an AI-based system comprising at least one processor executing above described method connected to a clock to measure time and to a memory to store data. Thus a behavior-controlled AI-based system is more secure relating to fully independent AI-based systems in particularly with the interactions with human-beings.

There is further provided, in accordance with an embodiment of the present invention, a system comprising an AI-based system comprising at least one processor able for executing above described method connected to a clock to measure time and to a memory to store data, whereby said information carrier comprising said algorithm. Thus the AI-based system and said information carrier may delivered separately and later said algorithm will transferred to said AI-based system done by the user itself, the customer, the salesman or so one.

The novel features of the present invention are set forth in the appended claims. Although the present invention was shown and described with references to the preferred embodiments, these are merely illustrative of the present invention and are not to be construed as a limitation thereof and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

1. Method for behavior control of an AI-based system, comprising at least one processor connected to a clock to measure time and to a memory, wherein said AI-based system is independently operable and is executing over the time at least the sequence of steps:
a) sample at least one physically observable of said AI-based system;
b) creation of at least one pair of variables dependent from said observables and/or from derivatives of said observables;
c) transformation of said at least one pair of variables into a multidimensional phase space;
d) creation of exactly one path within said phase space based on the sequence in time of said pairs of variables;
e) detect deviations of said path;
f) in the case of a deviation of the behavior of said AI-based system generate an information about the deviating behavior.

2. Method of claim 1, wherein in step a) ‘sample’ at least one physically observable of the AI-based system and at least one physically observable of the environment of said AI-based system is used.

3. Method of claim 1, wherein step e) ‘detect deviations’ comprises the sub-steps:
detection of at least one periodic pattern of said path within said phase space;
only if at least one pattern was recognized than:
only if said path leaves a given bandwidth of said pattern(s) than:
a derivation is detected.

4. Method of claim 1, wherein at least parts of said path are analyzed towards virtual displacements between two fixed ends to detect extremal values of terms from said pairs of variables, whereby the curvature on said extremal value is used to detect derivations.

5. Method of claim 3, wherein said patterns are recognized by methods of Symbolic Model Verification (SMV) whereby large numbers of states of the phase space were considered at a single step using Kernel-based Virtual Machines (KVM) for hardware virtualization or ‘deep learning’ as a branch of machine learning based on a set of algorithms that attempt to model high-level abstractions in data by using a deep graph with multiple processing layers, composed of multiple linear and non-linear transformations, optionally wherein disjoint areas of said patterns itself were used to detect derivations, more optionally wherein said recognized patterns were compared to stored patterns of similar AI-based systems to detect derivations, optionally dependent from the local density of the paths of the phase space, more optionally wherein said stored patterns are older ones from said AI-based system itself, optionally from times before an update of at least a part of said AI-based system was downloaded.

6. Method for behavior control of an AI-based system, comprising at least one processor connected to a clock to measure time and to a memory to store data, wherein said AI-based system is independently operable and is executing over the time at least the sequence of steps, whereby a process of distinguishing acceptable from non acceptable AI behavior is consisting of the following steps:
a) creating an empty behavioral profile of AI behavior;
b) in a learning phase gathering of external accessible data of the AI behavior of a AI-based system;
c) training the AI behavioral profile using said gathered external accessible data of the AI-based system;
d) if no significant new AI behavior captured the AI behavioral profile is deemed to be fully trained;
e) in an authentication phase, comparing newly captured AI behavior to already captured/trained AI behavior;
f) if newly captured AI behavior is substantial different to already captured AI behavior than:
g) inform a supervising authority.

7. Method of claim 6, wherein in said step b) ‘learning phase’ further is checking, if all “boundaries” of acceptable AI behavior are met.

8. Method of claim 6, wherein in said step c) ‘learning phase’ is comprising the sub-steps:
If newly gathered AI behavior is matching AI behavior captured in the training period, than accept this AI behavior as newly captured AI behavior and further train said AI-based system;
Else don't accept this AI behavior and inform said supervising authority.

9. Method of claim 6, wherein of a mechanical AI-based systems the following information can be gathered:
mechanical actions for a mechanical actor or extremity;
certain circumstances of the surrounding of the mechanical AI-based systems;
and this gathered information about external objects, further AI behavior of the mechanical AI-based system, as a reaction on those external objects can be gathered and trained into the AI behavioral profile of said mechanical AI-based system.

10. Method of claim 6, wherein the information about the deviating behavior of the AI-based system is sent to an supervising authority or is used to stop an AI controlled object, or wherein the AI-based system has to be checked itself, optionally using a data connection to an supervising authority, at each start time before it is able to command an AI controlled object.

11. Method of claim 6, wherein by effectively running the algorithm of the AI-based system in reverse, the supervising authority could discover the features the AI-based system uses to recognize different objects and to choice different decisions.

12. Method of claim 6, wherein said actor is a car or another mechanical moved object.

13. Method of claim 6, whereby a remote computer software system is a computer system connecter to said AI-base system by network means, where said remote computer software system is a traditional software computer system with or without mechanical actors or another AI-based software or a software system with mechanical actors, which is AI operated or by a traditional software on a computer system.

14. Method of claim 6, whereby the inventive method respectively the inventive system is used to supervise AI-based systems with are only acting in an informational space with no direct mechanical actors like mechanical extremities.

15. Method of claim 6, whereby at least three items of the following behavior of the AI-based system is captured: storing information in a non transient or transient memory connected or part of said AI-based system, opening, maintaining or closing a connection to a remote computer system, delivering or receiving data from said remote system, the content of the delivered or received data from said external system.

16. Method of claim 15, whereby the capturing of these information is realized by supervising the information flow between the AI-based system and other remote systems, by intercepting the possible information flows between those systems by enclosing the AI-based system into a “shell” where the AI-based system is only capable to communicate with other remote systems through this shell, so that all information flows can be intercepted.

17. Method of claim 15, whereby the capturing of these information realized by supervising the information flow is based on detecting of biased decision-making in relation to a larger set of similar supervised AI-based system.

18. Method of claim 6, whereby the gathering of external accessible data of the state of an only informational object such as a software system operated by an AI-based system is included.

19. Method of claim 6 written in form of an algorithm executable on a processor, whereby the algorithm is lying on an information carrier.

20. AI-based system comprising at least one processor connected to a clock to measure time and to a memory to store data, executing the method of claim 6.
